(19) United States
(12) Patent Application Publication
(10) Pub. No.: US 2026/0008712 A1
(43) Pub. Date: Jan. 8, 2026

(54) METHODS AND APPARATUS FOR MANUFACTURING A GLASS RIBBON

(71) Applicant: CORNING INCORPORATED, CORNING, NY (US)

(72) Inventors: Jason Arthur Howles, Corning, NY (US); JinSoo Kim, Asan (KR); Edward Lee Kimble, III, Painted Post, NY (US); Bonhyoung Koo, Seongnam-si (KR); Eric Lee Miller, Corning, NY (US); Brian Michael Palmer, Corning, NY (US); Eric Zachary VanSkiver, Watkins Glen, NY (US); Tytus Lee Zimmerman, Columbia Cross Roads, PA (US)

(21) Appl. No.: 18/992,337

(22) PCT Filed: Jul. 24, 2023
(86) PCT No.: PCT/US2023/028442

§ 371 Date: Jan. 8, 2025

Related U.S. Application Data
(60) Provisional application No. 63/369,529, filed on Jul. 27, 2022.

(51) Int. Cl. C03B 17/06; C03B 7/02; C03B 7/084

(52) U.S. Cl. CPC C03B 17/064; C03B 7/02; C03B 7/084

(57) ABSTRACT

A glass manufacturing apparatus includes a conduit in fluid communication with a delivery chamber and an inlet of a forming device. The conduit includes a closed sidewall surrounding a channel extending in a flow direction of the conduit. The glass manufacturing apparatus includes an enclosure surrounding the conduit and extending along a length of the conduit. The enclosure includes a refractory material in contact with the conduit such that an inner surface of the enclosure substantially matches a shape of an outer surface of the sidewall. Methods of manufacturing a glass ribbon are provided.

### CROSS REFERENCE TO RELATED APPLICATION

This application claims the benefit of priority under 35 U.S.C. § 119 of U.S. Provisional Application Ser. No. 63/369,529 filed on Jul. 27, 2022, the content of which is relied upon and incorporated herein by reference in its entirety.

### FIELD

The present disclosure relates generally to apparatus and methods for manufacturing a glass ribbon and, more particularly, to methods for manufacturing a glass ribbon with an enclosure surrounding a conduit.

### BACKGROUND

It is known to manufacture a glass ribbon with a forming device. Conventional forming devices comprise a conduit through which a molten material can flow. During operation, the conduit may be exposed to a relatively high temperature and stress. Over time, due to the temperature and stress, the conduit may experience leakage. Maintenance to repair the conduit is time-consuming and costly. Further, until maintenance is performed, the leaks in the conduit may negatively impact the quality of the glass ribbon.

### SUMMARY

The following presents a simplified summary of the disclosure to provide a basic understanding of some aspects described in the detailed description.

There are set forth methods of manufacturing glass with a conduit. Molten material can flow through a channel of the conduit. The conduit can be surrounded by an enclosure to reduce stress on the conduit. A biasing apparatus can facilitate thermal expansion and contraction of the conduit. For example, prior to molten material flowing within the conduit, the conduit may be heated, which can cause the conduit to expand or contract. The biasing apparatus can allow for the expansion or contraction in a length direction and/or a radial direction.

In aspects, a glass manufacturing apparatus comprises a conduit in fluid communication with a delivery chamber and an inlet of a forming device. The conduit comprises a closed sidewall surrounding a channel extending in a flow direction of the conduit. The glass manufacturing apparatus comprises an enclosure surrounding the conduit and extending along a length of the conduit. The enclosure comprises a refractory material in contact with the conduit such that an inner surface of the enclosure substantially matches a shape of an outer surface of the sidewall.

In aspects, the glass manufacturing apparatus further comprises an insulation layer surrounding the enclosure and spaced a distance apart from the conduit to form a gap. The enclosure is positioned within the gap between the insulation layer and the conduit.

In aspects, the conduit comprises a first section comprising a first diameter, a second section comprising a second diameter less than the first diameter, and a transition section connecting the first section and the second section. The enclosure is in contact with the first section, the second section, and the transition section.

In aspects, the transition section forms an angle relative to the first section that is greater than about 5 degrees.

In aspects, the glass manufacturing apparatus further comprises a biasing apparatus attached to the enclosure. The biasing apparatus is adjustable relative to the enclosure to accommodate a thermal expansion or a thermal contraction of the conduit in a length direction substantially parallel to the flow direction and a radial direction substantially perpendicular to the length direction.

In aspects, the biasing apparatus comprises a first spring extending along a first spring axis substantially parallel to the length direction. The first spring is configured to accommodate the thermal expansion or the thermal contraction of the conduit in the length direction.

In aspects, the biasing apparatus comprises a second spring extending along a second spring axis substantially perpendicular to the length direction. The second spring is configured to accommodate the thermal expansion or the thermal contraction of the conduit in the radial direction.

In aspects, a glass manufacturing apparatus comprises a conduit in fluid communication with a delivery chamber and an inlet of a forming device. The conduit comprises a closed sidewall surrounding a channel extending in a flow direction of the conduit. The glass manufacturing apparatus comprises an enclosure surrounding the conduit and extending along a length of the conduit. The enclosure comprises a refractory material in contact with the conduit. The glass manufacturing apparatus comprises a biasing apparatus attached to the enclosure. The biasing apparatus is adjustable relative to the enclosure to accommodate a thermal expansion or a thermal contraction of the conduit in a length direction substantially parallel to the flow direction and a radial direction substantially perpendicular to the length direction.

In aspects, the glass manufacturing apparatus further comprises an insulation layer surrounding the enclosure and spaced a distance apart from the conduit to form a gap. The enclosure is positioned within the gap between the insulation layer and the conduit.

In aspects, the conduit comprises a first section comprising a first diameter, a second section comprising a second diameter less than the first diameter, and a transition section connecting the first section and the second section. The enclosure is in contact with the first section, the second section, and the transition section.

In aspects, the transition section forms an angle relative to the first section that is greater than about 5 degrees.

In aspects, the biasing apparatus comprises a first spring extending along a first spring axis substantially parallel to the length direction. The first spring is configured to accommodate the thermal expansion or the thermal contraction of the conduit in the length direction.

In aspects, the biasing apparatus comprises a second spring extending along a second spring axis substantially perpendicular to the length direction. The second spring is configured to accommodate the thermal expansion or the thermal contraction of the conduit in the radial direction.

In aspects, methods of manufacturing a glass ribbon comprise flowing molten material within a channel of a conduit in a flow direction of the conduit. Methods comprise surrounding the conduit with an enclosure such that the enclosure contacts and reduces stress on the conduit. Methods comprise accommodating a dimensional change of the conduit due to a temperature change when the molten material flows within the channel.

In aspects, surrounding the conduit with the enclosure comprises delivering a suspension material in a gap surrounding the conduit and curing the suspension material to form the enclosure.

In aspects, accommodating the dimensional change comprises accommodating a thermal expansion or a thermal contraction of the conduit in a length direction substantially parallel to the flow direction.

In aspects, accommodating the dimensional change comprises accommodating a thermal expansion or a thermal contraction of the conduit in a radial direction substantially perpendicular to a length direction of the conduit.

Additional features and advantages of the aspects disclosed herein will be set forth in the detailed description that follows, and in part will be clear to those skilled in the art from that description or recognized by practicing the aspects described herein, including the detailed description which follows, the claims, as well as the appended drawings. It is to be understood that both the foregoing general description and the following detailed description present aspects intended to provide an overview or framework for understanding the nature and character of the aspects disclosed herein. The accompanying drawings are included to provide further understanding and are incorporated into and constitute a part of this specification. The drawings illustrate various aspects of the disclosure, and together with the description explain the principles and operations thereof.

### BRIEF DESCRIPTION OF THE DRAWINGS

These and other features, aspects and advantages are better understood when the following detailed description is read with reference to the accompanying drawings, in which:

FIG. 1 schematically illustrates example aspects of a glass manufacturing apparatus in accordance with aspects of the disclosure;

FIG. 2 illustrates a perspective cross-sectional view of the glass manufacturing apparatus along lines 2-2 of FIG. 1 in accordance with aspects of the disclosure;

FIG. 3 illustrates a side view of the glass manufacturing apparatus comprising a conduit in accordance with aspects of the disclosure;

FIG. 4 illustrates a side view of the conduit at focus area 4 of FIG. 3 in accordance with aspects of the disclosure;

FIG. 5 illustrates a side view of the conduit and a portion of an enclosure in accordance with aspects of the disclosure;

FIG. 6 illustrates a side view of a biasing apparatus in accordance with aspects of the disclosure;

FIG. 7 illustrates a side view of the biasing apparatus in accordance with aspects of the disclosure;

FIG. 8 illustrates a top-down view of a biasing apparatus in accordance with aspects of the disclosure; and

FIG. 9 illustrates a top-down view of the biasing apparatus in accordance with aspects of the disclosure.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, this disclosure may be embodied in many different forms and should not be construed as limited to the aspects set forth herein.

As used herein, the term “about” means that amounts, sizes, formulations, parameters, and other quantities and characteristics are not, and need not be, exact, but may be approximate and/or larger or smaller, as desired, reflecting tolerances, conversion factors, rounding off, measurement error and the like, and other factors known to those of skill in the art.

Ranges can be expressed herein as from “about” one value, and/or to “about” another value. When such a range is expressed, aspects include from the one value to the other value. Similarly, when values are expressed as approximations by use of the antecedent “about,” it will be understood that the value forms another aspect. It will be further understood that the endpoints of each of the ranges are significant both in relation to the other endpoint, and independently of the other endpoint.

Directional terms as used herein—for example up, down, right, left, front, back, top, bottom, upper, lower, etc.—are made only with reference to the figures as drawn and are not intended to imply absolute orientation.

Unless otherwise expressly stated, it is in no way intended that any methods set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including matters of logic relative to arrangement of steps, operational flow, order of components, or orientation of components; plain meaning derived from grammatical organization or punctuation, and; the number or type of aspects described in the specification.

As used herein, the singular forms “a,” “an” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including”, and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to represent that a described feature is equal or approximately equal to a value or description. For example, a “substantially planar” surface is intended to denote a surface that is planar or approximately planar. Moreover, “substantially” is intended to denote that two values are equal or approximately equal. The term “substantially” may denote values within about 10% of each other, for example, within about 5% of each other, or within about 2% of each other.

Modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first end and a second end generally correspond to end A and end B or two different ends.

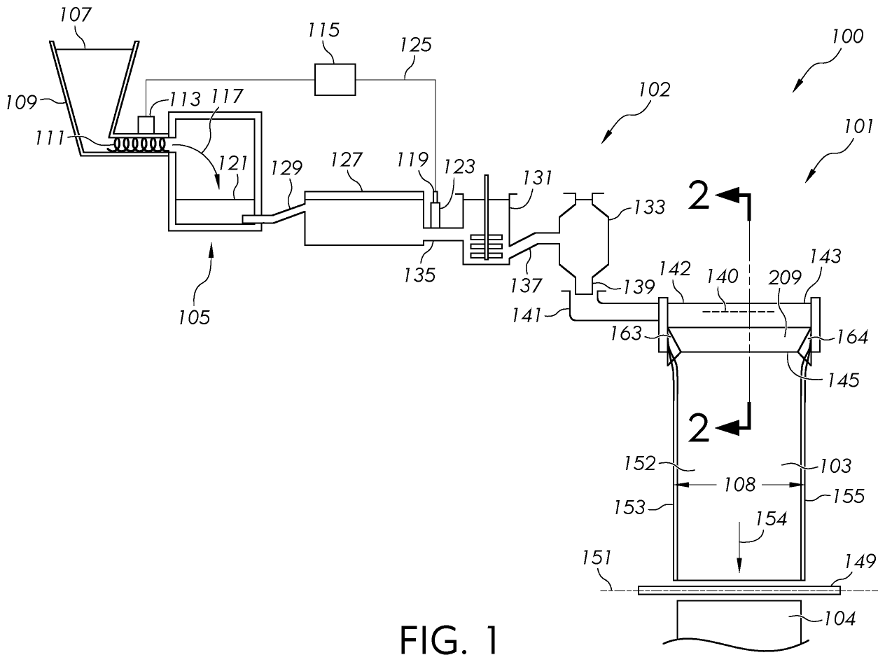

The present disclosure relates to a glass manufacturing apparatus and methods for producing a glass ribbon. Methods and apparatus for producing a glass ribbon from a glass material will now be described by way of example aspects. As schematically illustrated in FIG. 1, in aspects, an exemplary glass manufacturing apparatus 100 can comprise a glass melting and delivery apparatus 102 and a forming device 101 designed to produce a glass ribbon 103 from a quantity of molten material 121. The glass ribbon 103 can comprise a central portion 152 positioned between opposite edge portions (e.g., edge beads) formed along a first outer edge 153 and a second outer edge 155 of the glass ribbon 103, wherein a thickness of the edge portions can be greater than a thickness of the central portion. Additionally, in aspects, a separated glass ribbon 104 can be separated from the glass ribbon 103 along a separation path 151 by a glass separator 149 (e.g., scribe, score wheel, diamond tip, laser, etc.).

In aspects, the glass melting and delivery apparatus 102 can comprise a melting vessel 105 oriented to receive batch material 107 from a storage bin 109. The batch material 107 can be introduced by a batch delivery device 111 powered by a motor 113. In aspects, an optional controller 115 can be operated to activate the motor 113 to introduce a desired amount of batch material 107 into the melting vessel 105, as indicated by arrow 117. The melting vessel 105 can heat the batch material 107 to provide molten material 121. In aspects, a melt probe 119 can be employed to measure a level of molten material 121 within a standpipe 123 and communicate the measured information to the controller 115 by way of a communication line 125.

Additionally, in aspects, the glass melting and delivery apparatus 102 can comprise a first conditioning station comprising a fining vessel 127 located downstream from the melting vessel 105 and coupled to the melting vessel 105 by way of a first connecting conduit 129. In aspects, molten material 121 can be gravity fed from the melting vessel 105 to the fining vessel 127 by way of the first connecting conduit 129. For example, in aspects, gravity can drive the molten material 121 through an interior pathway of the first connecting conduit 129 from the melting vessel 105 to the fining vessel 127. Additionally, in aspects, bubbles can be removed from the molten material 121 within the fining vessel 127 by various techniques.

In aspects, the glass melting and delivery apparatus 102 can further comprise a second conditioning station comprising a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In aspects, molten material 121 can be gravity fed from the fining vessel 127 to the mixing chamber 131 by way of the second connecting conduit 135. For example, in aspects, gravity can drive the molten material 121 through an interior pathway of the second connecting conduit 135 from the fining vessel 127 to the mixing chamber 131.

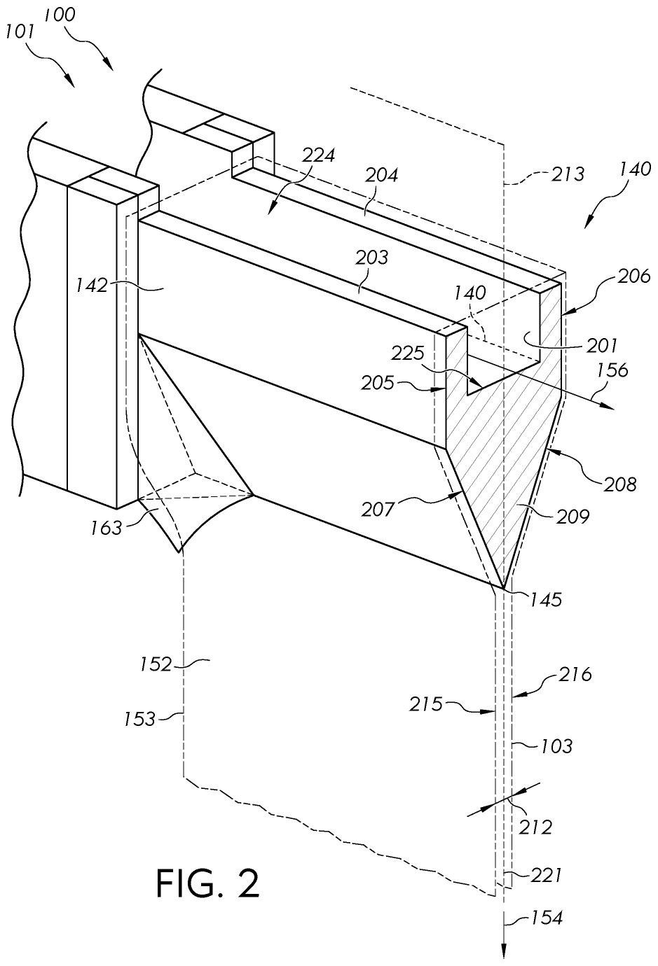

Additionally, in aspects, the glass melting and delivery apparatus 102 can comprise a third conditioning station comprising a delivery chamber 133 that can be located downstream from the mixing chamber 131. In aspects, the delivery chamber 133 can condition the molten material 121 to be fed into an inlet conduit 141. For example, the delivery chamber 133 can function as an accumulator and/or flow controller to adjust and provide a consistent flow of molten material 121 to the inlet conduit 141. As shown, the mixing chamber 131 can be coupled to the delivery chamber 133 by way of a third connecting conduit 137. In aspects, molten material 121 can be gravity fed from the mixing chamber 131 to the delivery chamber 133 by way of the third connecting conduit 137. For example, in aspects, gravity can drive the molten material 121 through an interior pathway of the third connecting conduit 137 from the mixing chamber 131 to the delivery chamber 133. As further illustrated, in aspects, a conduit 139 can be positioned to deliver molten material 121 to forming device 101, for example the inlet conduit 141 of the forming device 101. The forming device 101 can comprise a trough (e.g., trough 201 illustrated in FIG. 2) extending along a trough axis 140 between an inlet end 142 and an opposing end 143 of the forming device 101 opposite the inlet end 142. The inlet end 142 is the end of the trough 201 in proximity to the inlet conduit 141 through which the molten material 121 is received. The opposing end 143 is the end farthest from the inlet conduit 141.

By way of illustration, the forming device 101 shown and disclosed below can be provided to fusion draw molten material 121 off a bottom edge, defined as a root 145, of a forming wedge 209 to produce the glass ribbon 103. For example, in aspects, the molten material 121 can be delivered from the inlet conduit 141 to the forming device 101. The molten material 121 can then be formed into the glass ribbon 103 based, in part, on the structure of the forming device 101. For example, as shown, the molten material 121 can be drawn off the bottom edge (e.g., root 145) of the forming device 101 along a draw path extending in a travel direction 154 of the glass manufacturing apparatus 100. In aspects, edge directors 163, 164 can direct the molten material 121 off the forming device 101 and define, in part, a width 108 of the glass ribbon 103. In aspects, the width 108 of the glass ribbon 103 extends between the first outer edge 153 of the glass ribbon 103 and the second outer edge 155 of the glass ribbon 103.

In aspects, the width 108 of the glass ribbon 103, which extends between the first outer edge 153 of the glass ribbon 103 and the second outer edge 155 of the glass ribbon 103, can be greater than or equal to about 20 millimeters (mm), for example, greater than or equal to about 50 mm, for example, greater than or equal to about 100 mm, for example, greater than or equal to about 500 mm, for example, greater than or equal to about 1000 mm, for example, greater than or equal to about 2000 mm, for example, greater than or equal to about 3000 mm, for example, greater than or equal to about 4000 mm, although other widths less than or greater than the widths mentioned above can be provided in aspects. For example, in aspects, the width 108 can be within a range from about 20 mm to about 4000 mm, for example, within a range from about 50 mm to about 4000 mm, for example, within a range from about 100 mm to about 4000 mm, for example, within a range from about 500 mm to about 4000 mm, for example, within a range from about 1000 mm to about 4000 mm, for example, within a range from about 2000 mm to about 4000 mm, for example, within a range from about 3000 mm to about 4000 mm, for example, within a range from about 20 mm to about 3000 mm, for example, within a range from about 50 mm to about 3000 mm, for example, within a range from about 100 mm to about 3000 mm, for example, within a range from about 500 mm to about 3000 mm, for example, within a range from about 1000 mm to about 3000 mm, for example, within a range from about 2000 mm to about 3000 mm, for example, within a range from about 2000 mm to about 2500 mm, and all ranges and subranges therebetween.

FIG. 2 shows a cross-sectional perspective view of the forming device 101 along line 2-2 of FIG. 1. In aspects, the forming device 101 can comprise a trough 201 oriented to receive the molten material 121 from the inlet conduit 141. For illustrative purposes, cross-hatching of the molten material 121 is removed from FIG. 2 for clarity. The forming device 101 comprises a pair of weirs 203, 204 defining an opening 224 in the trough 201. The forming device 101 comprises a bottom surface 225, which may be substantially planar, and may extend at least partially between the inlet end 142 and the opposing end 143 (e.g., illustrated in FIG. 1). The bottom surface 225 can at least partially define the trough 201, for example, with the bottom surface 225 extending along a bottom of the trough 201 and the pair of weirs 203, 204 extending along opposing sides of the trough 201. The forming device 101 can further comprise the forming wedge 209 comprising a pair of downwardly inclined converging surface portions 207, 208 extending between opposed ends of the forming wedge 209. The pair of downwardly inclined converging surface portions 207, 208 of the forming wedge 209 can converge along the travel direction 154 to intersect along the root 145 (e.g., a bottom edge of the forming wedge 209 where the converging surface portions 207, 208 meet) of the forming device 101. A draw plane 213 of the glass manufacturing apparatus 100 can extend through the root 145 along the travel direction 154. In aspects, the glass ribbon 103 can be drawn in the travel direction 154 along the draw plane 213. As shown, the draw plane 213 can bisect the forming wedge 209 through the root 145 although, in aspects, the draw plane 213 can extend at other orientations relative to the root 145. In aspects, the glass ribbon 103 can move along a travel path 221 that may be co-planar with the draw plane 213 in the travel direction 154.

Additionally, the molten material 121 can flow in a flow direction 156 into and along the trough 201 of the forming device 101. The molten material 121 can then overflow from the trough 201 by flowing over corresponding weirs 203, 204, through the opening 224, and downwardly over the outer surfaces 205, 206 of the corresponding weirs 203, 204. Respective streams of molten material 121 can then flow along the downwardly inclined converging surface portions 207, 208 of the forming wedge 209 and be drawn off the root 145 of the forming device 101, where the flows converge and fuse into the glass ribbon 103. The glass ribbon 103 can then be drawn along the travel direction 154. In aspects, the glass ribbon 103 comprises one or more states of material based on a vertical location of the glass ribbon 103, i.e., distance from the root 145. For example, at a first location, the glass ribbon 103 can comprise the viscous molten material 121, and at a second location, the glass ribbon 103 can comprise an amorphous solid in a glassy state (e.g., a glass ribbon).

The glass ribbon 103 comprises a first major surface 215 and a second major surface 216 facing opposite directions and defining a thickness 212 (e.g., average thickness) of the glass ribbon 103 therebetween. In aspects, the thickness 212 of the glass ribbon 103 can be less than or equal to about 2 millimeters (mm), less than or equal to about 1 millimeter, less than or equal to about 0.5 millimeters, for example, less than or equal to about 300 micrometers (μm), less than or equal to about 200 micrometers, or less than or equal to about 100 micrometers, although other thicknesses may be provided in further aspects. For example, in aspects, the thickness 212 of the glass ribbon 103 can be within a range from about 20 micrometers to about 200 micrometers, within a range from about 50 micrometers to about 750 micrometers, within a range from about 100 micrometers to about 700 micrometers, within a range from about 200 micrometers to about 600 micrometers, within a range from about 300 micrometers to about 500 micrometers, within a range from about 50 micrometers to about 500 micrometers, within a range from about 50 micrometers to about 700 micrometers, within a range from about 50 micrometers to about 600 micrometers, within a range from about 50 micrometers to about 500 micrometers, within a range from about 50 micrometers to about 400 micrometers, within a range from about 50 micrometers to about 300 micrometers, within a range from about 50 micrometers to about 200 micrometers, within a range from about 50 micrometers to about 100 micrometers, within a range from about 25 micrometers to about 125 micrometers, comprising all ranges and subranges of thicknesses therebetween. In addition, the glass ribbon 103 can comprise a variety of compositions, for example, one or more of soda-lime glass, borosilicate glass, alumino-borosilicate glass, alkali-containing glass, alkali-free glass, aluminosilicate, borosilicate, boroaluminosilicate, silicate, glass-ceramic, or other materials comprising glass. In aspects, the glass ribbon 103 can comprise one or more of lithium fluoride (LiF), magnesium fluoride (MgF₂), calcium fluoride (CaF₂), barium fluoride (BaF₂), sapphire (Al₂O₃), zinc selenide (ZnSe), germanium (Ge) or other materials.

In aspects, the glass separator 149 (see FIG. 1) can separate the glass ribbon 104 from the glass ribbon 103 along the separation path 151 to provide a plurality of separated glass ribbons 104 (i.e., a plurality of sheets of glass). In aspects, a longer portion of the glass ribbon 104 may be coiled onto a storage roll. The separated glass ribbon can then be processed into a desired application, e.g., a display application. For example, the separated glass ribbon can be used in a wide range of display and non-display applications comprising, but not limited to, liquid crystal displays (LCDs), electrophoretic displays (EPD), organic light emitting diode displays (OLEDs), plasma display panels (PDPs), microLED displays, miniLED displays, organic light emitting diode lighting, light emitting diode lighting, augmented reality (AR), virtual reality (VR), touch sensors, photovoltaics, foldable phones, or other applications.

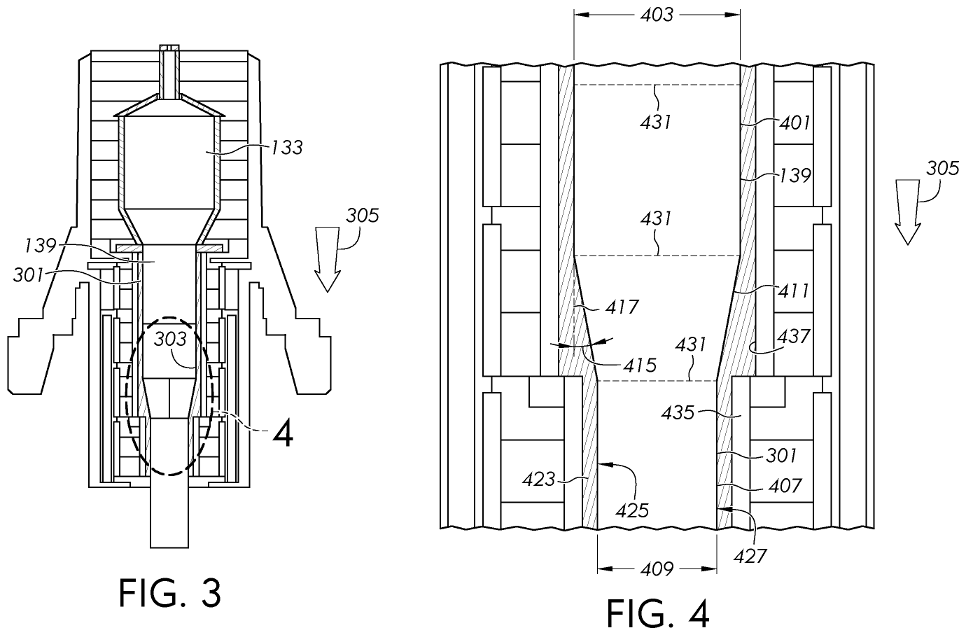

FIG. 3 illustrates a side view of the conduit 139 attached to the delivery chamber 133. The conduit 139 may be positioned between the delivery chamber 133 and the inlet conduit 141 (e.g., illustrated in FIG. 1) such that the conduit 139 can deliver the molten material 121 from the delivery chamber 133 to the inlet conduit 141. In this way, the conduit 139 is in fluid communication with the delivery chamber 133 and the inlet (e.g., the inlet conduit 141) of the forming device 101. The conduit 139 is substantially hollow and comprises a closed sidewall 301 surrounding a channel 303 extending in a flow direction 305 of the conduit 139. The molten material 121 can flow through the channel 303 along the flow direction 305 toward the inlet conduit 141. In aspects, the conduit 139 can extend substantially vertically between the delivery chamber 133 and the inlet conduit 141, such that the flow direction 305 may be in a direction of gravity. For example, the conduit 139 can extend along an axis, wherein the axis is in a direction of gravity.

In aspects, the closed sidewall 301 can be free of openings (e.g., voids, gaps, spaces, etc.) between the delivery chamber 133 and the inlet conduit 141. For example, by being closed and free of openings, the closed sidewall 301 may not define a free path between the interior of the conduit 139 and an exterior of the conduit 139. In this way, the closed sidewall 301 may surround the channel 303 while limiting air or unwanted contaminants from passing through the closed sidewall 301 and entering the channel 303. The closed sidewall 301 may comprise, for example, a metal material (e.g., platinum). In aspects, the conduit 139 can be connected to the delivery chamber 133 such that the closed sidewall 301 can be continuous from the delivery chamber 133 to the inlet conduit 141 to define a closed atmosphere from the delivery chamber 133, through the conduit 139, and to the inlet conduit 141. For example, the conduit 139 can be connected to the delivery chamber 133, such as by the closed sidewall 301 being connected to an outlet of the delivery chamber 133. In this way, the outlet of the delivery chamber 133 and the conduit 139 that is connected to the outlet of the delivery chamber 133 may be free of openings (e.g., voids, gaps, spaces, etc.) between an interior (e.g., of the outlet of the delivery chamber 133 and the conduit 139 that is connected to the outlet of the delivery chamber 133) where the molten material 121 flows through and an exterior.

FIG. 4 illustrates a side view of the conduit 139 as viewed at focus area 4 of FIG. 3. The conduit 139 may comprise a non-constant cross-sectional size in a direction that is orthogonal to the flow direction 305 between the delivery chamber 133 and the inlet conduit 141. For example, the cross-sectional size of the conduit 139 may be measured in a direction that is orthogonal to an axis along which the conduit 139 extends. In aspects, the conduit 139 may comprise a circular shape, in which case the cross-sectional size of the channel 303 can comprise a diameter. For example, the conduit 139 can comprise a first section 401 comprising a first diameter 403 and a second section 407 comprising a second diameter 409 that is less than the first diameter 403. In aspects, the second section 407 may be downstream from the first section 401 relative to the flow direction 305, such that the conduit 139 decreases in diameter along the flow direction 305. In aspects, the conduit 139 can comprise a transition section 411 connecting the first section 401 and the second section 407. The transition section 411 can comprise a decreasing diameter from the first section 401 to the second section 407, with the transition section 411 comprising the first diameter 403 at the first section 401, and the second diameter 409 at the second section 407. In this way, the transition section 411 can form an angle 415 relative to the first section 401, for example, with the angle 415 defined between an axis 417 along which the first section 401 extends and the transition section 411. In aspects, the angle 415 can be greater than about 5 degrees.

The glass manufacturing apparatus 100 can comprise an enclosure 423 surrounding the conduit 139 and extending along a length of the conduit 139. In aspects, the enclosure 423 can comprise a refractory material in contact with the conduit 139 such that an inner surface 425 of the enclosure 423 substantially matches a shape of an outer surface 427 of the sidewall 301. For example, by extending along the length of the conduit 139, the enclosure 423 can be in contact with the conduit 139 at a top of the conduit 139 (e.g., at a location where the conduit 139 is attached to the delivery chamber 133) to a location below the transition section 411. In this way, the enclosure 423 may be in contact with the first section 401, the second section 407, and the transition section 411. By surrounding the conduit 139, the enclosure 423 can extend circumferentially around the outer surface 427 such that enclosure 423 encircles the conduit 139 (e.g., when the conduit 139 comprises a circular cross-sectional shape).

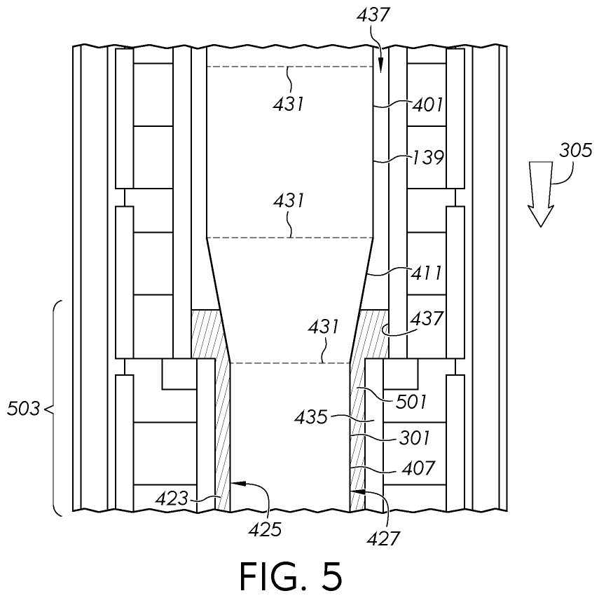

In aspects, by substantially matching the shape of the outer surface 427, the inner surface 425 of the enclosure 423 can conform to or take the same shape as the outer surface 427. In aspects, the conduit 139 can be formed by attaching (e.g., welding, adhering, etc.) sections together, for example, metal sections. As a result of the forming process, the conduit 139 may comprise one or more weld seams 431, which are uneven surfaces that define a location at which two sections have been attached (e.g., by welding). As such, the outer surface 427 may not be completely smooth at all locations, but, instead, may comprise uneven portions at the weld seams 431, with the uneven portions defining a non-constant diameter with peaks, valleys, undulations, etc. As described relative to FIG. 5, the enclosure 423 provides several benefits, one of which is that the enclosure 423 may be formed to substantially match the shape of the outer surface 427 at the weld seams 431.

In aspects, the glass manufacturing apparatus 100 can comprise an insulation layer 435 surrounding the enclosure 423. The insulation layer 435 is spaced a distance apart from the conduit 139 to form a gap 437 between the insulation layer 435 and the conduit 139. In aspects, the gap 437 can comprise a radial thickness (e.g., distance separating the insulation layer 435 from the conduit 139) within a range from about 4.7 millimeters (mm) to about 25 mm. In aspects, the insulation layer 435 can comprise one or more bricks comprising a thermally insulating or refractory material. In aspects, a metal winding can be positioned at an inner surface of the insulation layer 435, with the metal winding configured to conduct electrical current and generate heat. By surrounding the enclosure 423, the insulation layer 435 can extend circumferentially around the enclosure 423.

The enclosure 423 can be positioned within the gap 437 and may contact the insulation layer 435 at an outer radial surface and the conduit 139 at an inner radial surface (e.g., at the inner surface 425). FIG. 5 illustrates a side view of the conduit 139 with the enclosure 423 being formed within the gap 437. For example, initially, the gap 437 may be empty and devoid of material, such that a hollow channel surrounds the conduit 139 between the conduit 139 and the insulation layer 435. Methods of manufacturing the glass ribbon 103 can comprise surrounding the conduit 139 with the enclosure 423 such that the enclosure 423 contacts and reduces stress on the conduit 139. In aspects, surrounding the conduit 139 with the enclosure 423 can comprise delivering a suspension material 501 in the gap 437 surrounding the conduit 139 and curing the suspension material 501 to form the enclosure 423. The suspension material 501 can comprise a semi-liquid suspension (e.g., or semi-liquid material) comprising a mixture of, for example, alumina (e.g., in a solid form) and water (e.g., in a liquid form). In aspects, the suspension material 501 (e.g., and, thus, the enclosure 423) can comprise an alumina-based castable material, such as, for example, 95% alumina with a phosphate component. In aspects, a coefficient of thermal expansion of the enclosure 423 can substantially match a coefficient of thermal expansion of the conduit 139. The suspension material 501 can be delivered to the gap 437, for example, by being poured into the gap 437. In aspects, the gap 437 may not initially be fully filled with the suspension material 501, but, rather, a portion of (e.g., less than all) of the gap 437 may be filled with the suspension material 501. For example, the suspension material 501 can initially be in contact with the second section 407 and a lower portion of the transition section 411 of the conduit 139. The first section 401 and an upper portion of the transition section 411 may be uncovered by and not in contact with the suspension material 501.

After the suspension material 501 has been delivered to the gap 437, the suspension material 501 can be cured, which allows the suspension material 501 to harden (e.g., into a solid state) and form a first portion 503 of the enclosure 423. In aspects, the suspension material 501 can be cured in several ways, for example, by applying heat to the suspension material 501 and/or by allowing the suspension material 501 to cure over a period of time. After the suspension material 501 has cured to form the first portion 503 of the enclosure 423, an additional amount of suspension material 501 can be delivered to the gap 437 over the first portion 503, with the additional amount of suspension material 501 being cured to form additional portions of the enclosure 423. In this way, the enclosure 423 can be formed within the gap 437 in stages, with the suspension material 501 being delivered and cured to form a plurality of portions that, together, form the enclosure 423.

Delivering the suspension material 501 to the gap 437 is beneficial due to the suspension material substantially matching the shape of the outer surface 427 of the conduit 139. For example, upon delivering the suspension material 501 to the gap 437, the suspension material 501 can conform to the shape of the outer surface 427. In aspects, the outer surface 427 may comprise one or more weld seams 431 representing a non-smooth surface. Due to the suspension material 501 initially being delivered in a non-solid and non-rigid state, the suspension material 501 can surround and match the shape at smooth portions of the enclosure 423 (e.g., away from the weld seams 431) and non-smooth portions of the enclosure 423 (e.g., at the weld seams 431). In addition, the first section 401 and/or the second section 407 may comprise a non-constant diameter, for example, as a result of the manufacturing process, which may be within about +/−5% of an average diameter of the first section 401 and/or the second section 407. The suspension material 501 can match the shape of the first section 401 and the second section 407 regardless of dimensional variations due to the manufacturing process.

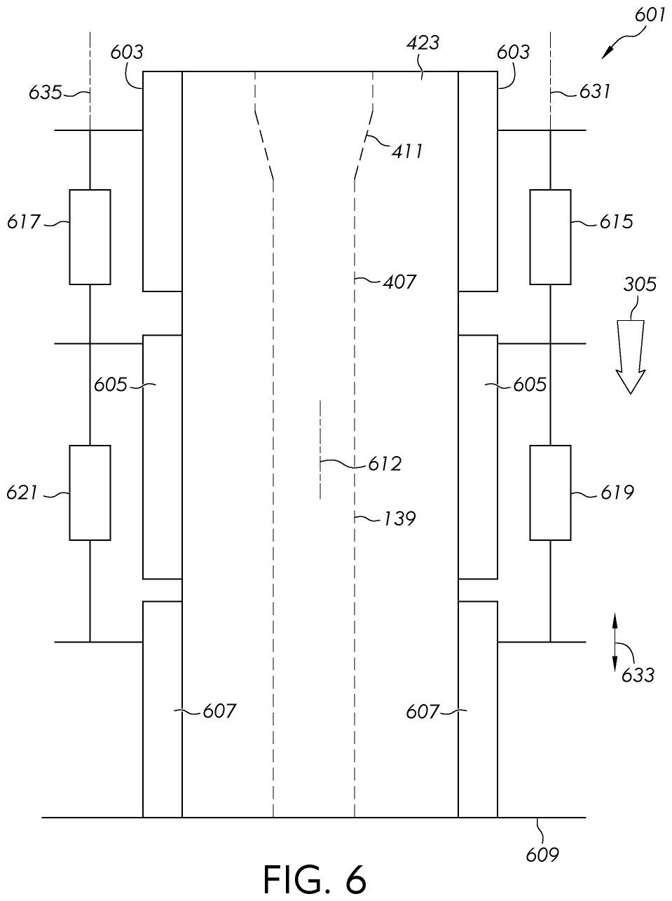

FIG. 6 illustrates a side view of a portion of the enclosure 423. In aspects, the enclosure 423 can comprise a biasing apparatus 601 that can accommodate a thermal expansion or thermal contraction of the conduit 139 (e.g., illustrated in dashed lines due to being housed within the enclosure 423). For example, the biasing apparatus 601 can comprise one or more support structures that can contact the enclosure 423 and may partially, or completely, surround the enclosure 423. In aspects, the one or more support structures can comprise a first support structure 603, a second support structure 605, and a third support structure 607. The support structures 603, 605, 607 can be attached to the outer surface of the enclosure 423 at a location at, or below, the transition section 411. For example, the first support structure 603 can be attached to the enclosure 423 at a location that is at, or below, the transition section 411 relative to the flow direction 305. The second support structure 605 can be attached to the enclosure 423 at a location downstream from the first support structure 603 relative to the flow direction 305, and at a location that is below the transition section 411 (e.g., in contact with the second section 407). The third support structure 607 can be attached to the enclosure 423 at a location downstream from the second support structure 605 relative to the flow direction 305, and at a location that is below the transition section 411 (e.g., in contact with the second section 407).

In aspects, the support structures 603, 605, 607 can comprise a metal material and may be attached to the enclosure 423 such that relative movement between the enclosure and the support structures 603, 605, 607 is limited. The support structures 603, 605, 607 can be attached to the enclosure 423 in several ways, for example, with mechanical fasteners, one-piece formation, adhesives or welding, etc. In aspects, the support structures 603, 605, 607 can form a hollow frame within which the enclosure 423 is received, with the support structures 603, 605, 607 providing a compressive force to the enclosure 423 such that the support structures 603, 605, 607 may attach to the enclosure 423 by surrounding and compressing the enclosure 423. In this way, the first support structure 603 can encircle and surround the enclosure 423 at a first axial location along the conduit 139, the second support structure 605 can encircle and surround the enclosure 423 at a second axial location along the conduit 139 downstream from the first axial location, and the third support structure 607 can encircle and surround the enclosure 423 at a third axial location along the conduit 139 downstream from the second axial location. In aspects, the first support structure 603 may be spaced apart from and not attached to the second support structure 605, and the second support structure 605 may be spaced apart from and not attached to the third support structure 607.

In aspects, the biasing apparatus 601 can comprise a base 609 that is attached to a bottom end of the enclosure 423 and the third support structure 607. The base 609 can be substantially planar such that the bottom end of the enclosure 423 (e.g., and the conduit 139) can be in contact with and rest upon the base 609. The base 609 can be attached to the third support structure 607 in several ways, for example, with mechanical fasteners, one-piece formation, adhesives or welding, etc. In aspects, the base 609 may comprise an opening through which the conduit 139 can extend through.

The biasing apparatus 601 can comprise one or more springs that can be attached to the support structures 603, 605, 607 to facilitate thermal expansion or thermal contraction of the conduit 139. For example, the one or more springs can comprise a first spring 615, a second spring 617, a third spring 619, and a fourth spring 621. The springs 615, 617, 619, 621 can comprise an elastic object that can store mechanical energy. In aspects, the springs 615, 617, 619, 621 can comprise several types of springs, for example, coil springs (e.g., a metal or elastic material with a helical shape that can expand when a load is applied and can return to a natural length when unloaded), gas springs (e.g., an enclosed cylinder comprising a compressed gas with a moving piston that stores potential energy), etc. The first spring 615 can be attached to the first support structure 603 and the second support structure 605. In aspects, the second spring 617 can be located on an opposite side of the enclosure 423 from the first spring 615 (e.g., about 180 degrees offset from the first spring 615), with the second spring 617 attached to the first support structure 603 and the second support structure 605. As such, the first spring 615 and the second spring 617 can be located at substantially the same position along an axis 612 of the conduit 139 on opposing sides of the enclosure 423. The first spring 615 and the second spring 617 can be attached to the first support structure 603 and the second support structure 605 in several ways, for example, with mechanical fasteners, adhesives, welding, etc.

The third spring 619 can be positioned downstream from the first spring 615 relative to the flow direction 305, and the fourth spring 621 can be positioned downstream from the second spring 617 relative to the flow direction 305. In aspects, the third spring 619 can be attached to the second support structure 605 and the third support structure 607. In aspects, the fourth spring 621 can be located on an opposite side of the enclosure 423 from the third spring 619 (e.g., about 180 degrees offset from the third spring 619), with the fourth spring 621 attached to the second support structure 605 and the third support structure 607. As such, the third spring 619 and the fourth spring 621 can be located at substantially the same position along the axis 612 on opposing sides of the enclosure 423. The third spring 619 and the fourth spring 621 can be attached to the second support structure 605 and the third support structure 607 in several ways, for example, with mechanical fasteners, adhesives, welding, etc.

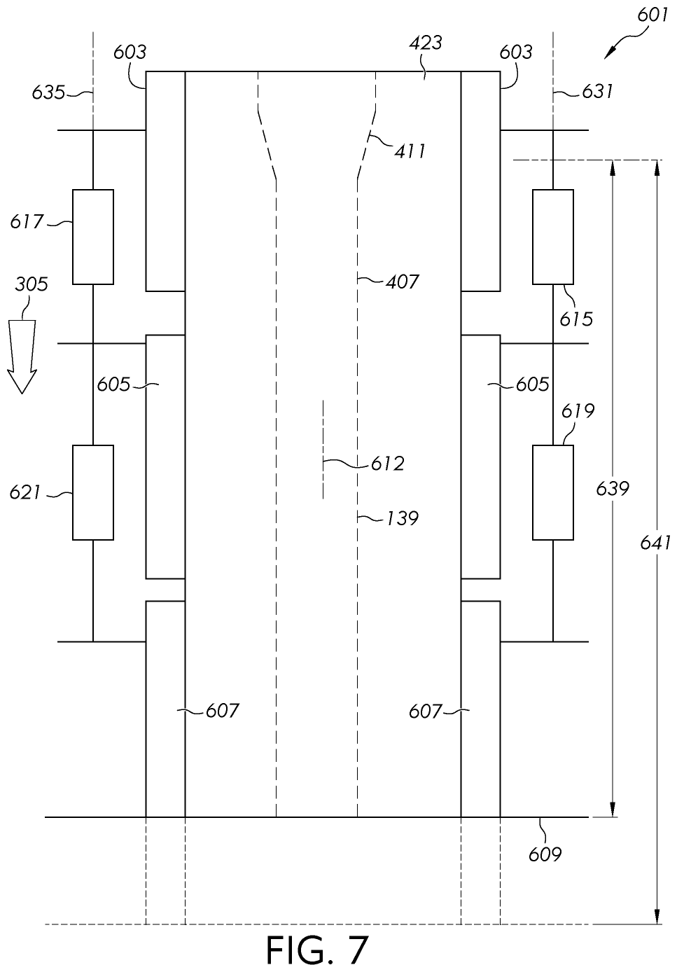

The first spring 615 can extend along a first spring axis 631 substantially parallel to a length direction 633 along which the conduit 139 extends. The third spring 619 can extend along the first spring axis 631. In aspects, the second spring 617 can extend along a second spring axis 635 substantially parallel to the length direction 633. The fourth spring 621 can extend along the second spring axis 635. The first spring 615 and the second spring 617 can accommodate the thermal expansion or the thermal contraction of the conduit 139 in the length direction 633. For example, referring to FIGS. 6-7, prior to the conduit 139 heating up, the conduit 139 may comprise a first length 639 between the bottom of the transition section 411 (e.g., at the intersection of the transition section 411 and the second section 407) and the bottom of the conduit 139. The conduit 139 may be heated prior to the molten material 121 flowing within the channel 303. Upon heating up, the conduit 139 may experience thermal expansion, such that the conduit 139 may comprise a second length 641 between the bottom of the transition section 411 and the bottom of the conduit 139, with the second length 641 greater than the first length. Due to the thermal expansion of the conduit 139, the enclosure 423 may likewise expand in the length direction 633.

In aspects, to accommodate the thermal expansion of the conduit 139 and the enclosure 423, the springs 615, 617, 619, 621 may expand in the length direction 633. For example, as the conduit 139 and the enclosure 423 expand in the length direction 633, the first spring 615 and the second spring 617 can likewise expand, thus allowing the second support structure 605 to move downwardly and away from the first support structure 603 in the length direction 633. Further, in aspects, as the conduit 139 and the enclosure 423 expand in the length direction 633, the third spring 619 and the fourth spring 621 can likewise expand, thus allowing the third support structure 607 to move downwardly and away from the second support structure 605 in the length direction 633. In this way, the base 609 can move downwardly such that the conduit 139 can expand from the first length 639 to the second length 641. The expanded second length 641 of the conduit 139 and the enclosure 423 is illustrated with dashed lines in FIG. 7. The springs 615, 617, 619, 621 can bias the support structures 603, 605, 607 to revert to the first length 639 such that, after the conduit 139 and the enclosure 423 cool down, the conduit 139 and the enclosure 423 may thermally contract in the length direction 633 such that the conduit 139 can return to the first length 639.

The biasing apparatus 601, comprising the support structures 603, 605, 607, the base 609, and the springs 615, 617, 619, 621, can therefore be attached to the enclosure 423 and may be adjustable relative to the enclosure 423 to accommodate the thermal expansion or the thermal contraction of the conduit 139 in the length direction 633 substantially parallel to the flow direction 305. By being adjustable relative to the enclosure 423, the biasing apparatus 601 can allow the conduit 139 and the enclosure 423 to move (e.g., due to thermal expansion and contraction) in the length direction 633, while remaining attached to the enclosure 423. The biasing apparatus 601 can support a bottom of the conduit 139 and the enclosure 423 with the base 609, while allowing the base 609 to move downwardly when thermal expansion occurs. In this way, methods can comprise accommodating a dimensional change of the conduit 139 due to a temperature change when the conduit 139 is heated (e.g., prior to the molten material 121 flowing within the channel 303). The dimensional change can comprise a change in length of the conduit 139. As such, accommodating the dimensional change can comprise accommodating a thermal expansion or a thermal contraction of the conduit 139 in the length direction 633 substantially parallel to the flow direction 305.

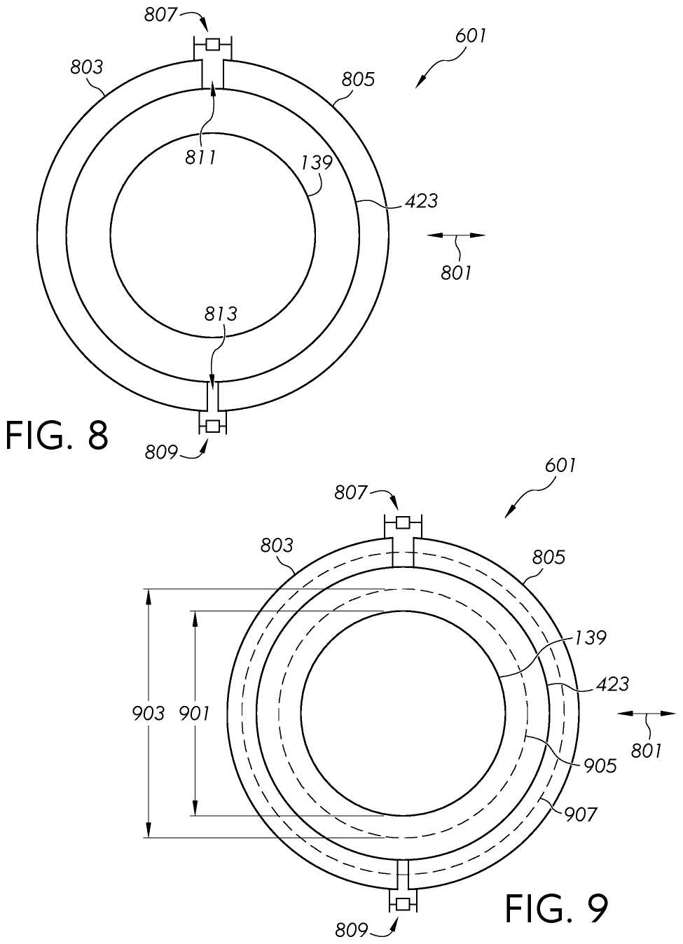

FIG. 8 illustrates a top-down view of the enclosure 423. In aspects, the biasing apparatus 601 can accommodate a thermal expansion or a thermal contraction of the conduit 139 in a radial direction 801 substantially perpendicular to the length direction 633 (e.g., into and out of the page). For example, the biasing apparatus 601 can comprise one or more support structures that can contact the enclosure 423 and may partially, or completely, surround the enclosure 423. In aspects, the one or more support structures can comprise a first support structure 803 and a second support structure 805. The support structures 803, 805 can be attached to the outer surface of the enclosure 423 at a location at, or below, the transition section 411. For example, in aspects, the support structures 803, 805 can be attached to the enclosure 423 at a location that is below the transition section 411 (e.g., in contact with the second section 407).

In aspects, the support structures 803, 805 can comprise a metal material and may be attached to the enclosure 423 such that relative movement between the enclosure and the support structures 803, 805 is limited. In aspects, the support structures 803, 805 can be attached to the enclosure 423 in several ways, for example, with mechanical fasteners, one-piece formation, adhesives or welding, etc. The support structures 803, 805 can comprise a shape that substantially matches a shape of the outer surface of the enclosure 423, for example, a rounded, circular shape. As such, the first support structure 803 and the second support structure 805 can sandwich the enclosure 423 (e.g., with the enclosure 423 positioned between the first support structure 803 and the second support structure 805) and, in aspects, provide a compressive force to the enclosure 423. In aspects, the first support structure 803 may be spaced apart from the second support structure 805.

In aspects, the biasing apparatus 601 can comprise one or more springs that can be attached to the support structures 803, 805 to facilitate thermal expansion or thermal contraction of the conduit 139 in the radial direction 801. For example, the one or more springs can comprise a first spring 807 and a second spring 809. The springs 807, 809 can comprise an elastic object that can store mechanical energy. In aspects, the springs 807, 809 can comprise several types of springs, for example, coil springs (e.g., a metal or elastic material with a helical shape that can expand when a load is applied and can return to a natural length when unloaded), gas springs (e.g., an enclosed cylinder comprising a compressed gas with a moving piston that stores potential energy), etc. The first spring 807 can be attached to a first end of the first support structure 803 and a first end of the second support structure 805, with the first ends of the support structures 803, 805 adjacent to one another. In aspects, a first gap 811 may exist between the first support structure 803 and the second support structure 805. The second spring 809 can be attached to a second end of the first support structure 803 and a second end of the second support structure 805, with the second ends of the support structures 803, 805 adjacent to one another. In aspects, a second gap 813 may exist between the first support structure 803 and the second support structure 805. The first spring 807 may be located on an opposite side of the enclosure 423 from the second spring 809 (e.g., about 180 degrees offset from the first spring 807). The springs 807, 809 can be attached to the support structures 803, 805 in several ways, for example, with mechanical fasteners, adhesives, welding, etc.

Referring to FIGS. 8-9, the first spring 807 and the second spring 809 can accommodate the thermal expansion or the thermal contraction of the conduit 139 in the radial direction 801. For example, prior to the conduit 139 heating up, the conduit 139 may comprise a first diameter 901. The conduit 139 may heat up due to the molten material 121 flowing within the channel 303. Upon heating up, the conduit 139 may experience thermal expansion, such that the conduit 139 may comprise a second diameter 903, with the second length 641 greater than the first length. An expanded perimeter 905 of the conduit 139 and an expanded perimeter 907 of the enclosure 423 are illustrated with dashed lines in FIG. 9. Due to the thermal expansion of the conduit 139, the enclosure 423 may likewise expand in the radial direction 801. In aspects, to accommodate the thermal expansion of the conduit 139 and the enclosure 423, the springs 807, 809 may expand in the radial direction 801. For example, as the conduit 139 and the enclosure 423 expand in the radial direction 801 (e.g., with the thermal expansion illustrated in FIG. 9 with dashed lines), the first spring 807 and the second spring 809 can likewise expand, thus allowing the first support structure 803 and the second support structure 805 to move apart. In this way, the first gap 811 and the second gap 813 may increase in size. The springs 807, 809 can bias the support structures 803, 805 to revert to the first diameter 901 such that, after the conduit 139 and the enclosure 423 cool down, the conduit 139 and the enclosure 423 may thermally contract in the radial direction 801 such that the conduit 139 can return to the first diameter 901.

The biasing apparatus 601, comprising the support structures 803, 805 and the springs 807, 809, can therefore be attached to the enclosure 423 and may be adjustable relative to the enclosure 423 to accommodate the thermal expansion or the thermal contraction of the conduit 139 in the radial direction 801 substantially perpendicular to the length direction 633. By being adjustable relative to the enclosure 423, the biasing apparatus 601 can allow the conduit 139 and the enclosure 423 to move (e.g., due to thermal expansion and contraction) in the radial direction 801, while remaining attached to the enclosure 423. In this way, methods can comprise accommodating a dimensional change of the conduit 139 due to a temperature change when the molten material 121 flows within the channel 303. The dimensional change can comprise a change in diameter of the conduit 139. As such, accommodating the dimensional change can comprise accommodating a thermal expansion or a thermal contraction of the conduit 139 in the radial direction 801.

The enclosure 423 and the biasing apparatus 601 can provide several benefits. For example, during operation when the molten material 121 flows through the conduit 139, the conduit 139 may experience stress and drag forces, which can result in strain rates and rupture at elevated temperatures. In particular, a high strain can cause the conduit 139 to stretch and thin in localized regions over time, resulting in cracks, for example, at the weld seams 431. By surrounding the conduit 139 with the enclosure 423, these stresses upon the conduit 139 can be reduced. For example, the conduit 139 can comprise an alloy of platinum and rhodium (e.g., 90% platinum and 10% rhodium, or 80% platinum and 20% rhodium). The enclosure 423 can comprise a castable material layer that surrounds the conduit 139 to provide additional support by reinforcing and/or providing structural support, which can reduce localized stresses by spreading the stresses over a larger area. In this way, the enclosure 423 can reduce stress in the axial and radial directions, thus reducing the likelihood of creep (e.g., deformation of the conduit 139) and, thus, cracks in the conduit 139. In this way, the enclosure 423 can surround the conduit 139 such that the enclosure 423 contacts and reduces stress on the conduit 139.

While the enclosure 423 can surround and support the conduit 139, the biasing apparatus 601 can facilitate thermal expansion and thermal contraction of the conduit 139. For example, during operation, the conduit 139 can heat and cool, with the springs of the biasing apparatus 601 allowing expansion/contraction in the axial and radial directions. The enclosure 423 can further provide additional thermal insulation to the conduit 139, which can improve the melting process. In addition, the transition section 411 can comprise the angle 415 that is greater than about 5 degrees. A benefit of this angle 415 is that an improved balance of stresses (e.g., axial stress and hoop stress) can balance impedance during the flow of the molten material 121 through the conduit 139.

It should be understood that while various aspects have been described in detail relative to certain illustrative and specific examples thereof, the present disclosure should not be considered limited to such, as numerous modifications and combinations of the disclosed features are possible without departing from the scope of the following claims.

1. A glass manufacturing apparatus comprising:
a conduit in fluid communication with a delivery chamber and an inlet of a forming device, the conduit comprising a closed sidewall surrounding a channel extending in a flow direction of the conduit; and
an enclosure surrounding the conduit and extending along a length of the conduit, the enclosure comprising a refractory material in contact with the conduit such that an inner surface of the enclosure substantially matches a shape of an outer surface of the sidewall.

2. The glass manufacturing apparatus of claim 1, further comprising an insulation layer surrounding the enclosure and spaced a distance apart from the conduit to form a gap, the enclosure positioned within the gap between the insulation layer and the conduit.

3. The glass manufacturing apparatus of claim 1, wherein the conduit comprises a first section comprising a first diameter, a second section comprising a second diameter less than the first diameter, and a transition section connecting the first section and the second section, the enclosure in contact with the first section, the second section, and the transition section.

4. The glass manufacturing apparatus of claim 3, wherein the transition section forms an angle relative to the first section that is greater than about 5 degrees.

5. The glass manufacturing apparatus of claim 1, further comprising a biasing apparatus attached to the enclosure, the biasing apparatus adjustable relative to the enclosure to accommodate a thermal expansion or a thermal contraction of the conduit in a length direction substantially parallel to the flow direction and a radial direction substantially perpendicular to the length direction.

6. The glass manufacturing apparatus of claim 5, wherein the biasing apparatus comprises a first spring extending along a first spring axis substantially parallel to the length direction, the first spring configured to accommodate the thermal expansion or the thermal contraction of the conduit in the length direction.

7. The glass manufacturing apparatus of claim 5, wherein the biasing apparatus comprises a second spring extending along a second spring axis substantially perpendicular to the length direction, the second spring configured to accommodate the thermal expansion or the thermal contraction of the conduit in the radial direction.

8. A glass manufacturing apparatus comprising:
a conduit in fluid communication with a delivery chamber and an inlet of a forming device, the conduit comprising a closed sidewall surrounding a channel extending in a flow direction of the conduit;
an enclosure surrounding the conduit and extending along a length of the conduit, the enclosure comprising a refractory material in contact with the conduit; and
a biasing apparatus attached to the enclosure, the biasing apparatus adjustable relative to the enclosure to accommodate a thermal expansion or a thermal contraction of the conduit in a length direction substantially parallel to the flow direction and a radial direction substantially perpendicular to the length direction.

9. The glass manufacturing apparatus of claim 8, further comprising an insulation layer surrounding the enclosure and spaced a distance apart from the conduit to form a gap, the enclosure positioned within the gap between the insulation layer and the conduit.

10. The glass manufacturing apparatus of claim 8, wherein the conduit comprises a first section comprising a first diameter, a second section comprising a second diameter less than the first diameter, and a transition section connecting the first section and the second section, the enclosure in contact with the first section, the second section, and the transition section.

11. The glass manufacturing apparatus of claim 10, wherein the transition section forms an angle relative to the first section that is greater than about 5 degrees.

12. The glass manufacturing apparatus of claim 8, wherein the biasing apparatus comprises a first spring extending along a first spring axis substantially parallel to the length direction, the first spring configured to accommodate the thermal expansion or the thermal contraction of the conduit in the length direction.

13. The glass manufacturing apparatus of claim 8, wherein the biasing apparatus comprises a second spring extending along a second spring axis substantially perpendicular to the length direction, the second spring configured to accommodate the thermal expansion or the thermal contraction of the conduit in the radial direction.

14. A method of manufacturing a glass ribbon comprising:
flowing molten material within a channel of a conduit in a flow direction of the conduit;
surrounding the conduit with an enclosure such that the enclosure contacts and reduces stress on the conduit; and
accommodating a dimensional change of the conduit due to a temperature change when the molten material flows within the channel.

15. The method of claim 14, wherein surrounding the conduit with the enclosure comprises delivering a suspension material in a gap surrounding the conduit and curing the suspension material to form the enclosure.

16. The method of claim 14, wherein accommodating the dimensional change comprises accommodating a thermal expansion or a thermal contraction of the conduit in a length direction substantially parallel to the flow direction.

17. The method of claim 14, wherein accommodating the dimensional change comprises accommodating a thermal expansion or a thermal contraction of the conduit in a radial direction substantially perpendicular to a length direction of the conduit.
